(19) United States
(12) Patent Application Publication
(10) Pub. No.: US 2020/0143354 A1
(43) Pub. Date: May 7, 2020

(54) EXPLOITATION OF AUGMENTED REALITY AND CRYPTOTOKEN ECONOMICS IN AN INFORMATION-CENTRIC NETWORK OF SMARTPHONE USERS AND OTHER IMAGING CYBORGS

(71) Applicant: ARKNET, INC., Oro Valley, AZ (US)

(72) Inventors: David LaMountain, Coventry, RI (US); Jon N. Leonard, Oro Valley, AZ (US)

(73) Assignee: ARKNET, INC., Oro Valley, AZ (US)

(21) Appl. No.: 16/674,559

(22) Filed: Nov. 5, 2019

Related U.S. Application Data
(60) Provisional application No. 62/755,589, filed on Nov. 5, 2018.

(51) Int. Cl. G06Q 20/32; H04W 4/02; G06Q 20/36; G06Q 20/38; H04L 9/06

(52) U.S. Cl. CPC G06Q 20/322; H04W 4/023; G06Q 20/3678; H04L 2209/56; H04L 9/0637; G06Q 2220/00; G06Q 20/389

(57) ABSTRACT

A method and system provides a mobile device app that enables users to not only view augmented reality objects and access content, but also to establish, deploy, and manage their own augmented reality objects for viewing and interaction with by other users of the mobile app. The method and system of the invention thus serves as the foundation for an augmented reality ecosystem in which any user can create an augmented reality object for viewing and interaction with by all of a subset of other users. The ecosystem may include its own cryptocurrency to facilitate transactions arising from interaction with the augmented reality objects, and to facilitate compensation to digital content providers. In addition, ownership of augmented reality objects created by the method and system of the invention may be recorded and verified utilizing blockchain technology.

This application claims the benefit of U.S. Provisional Appl. Ser. No. 62/755,589, filed Nov. 5, 2018.

### BACKGROUND OF THE INVENTION

### 1. Field of the Invention

The invention relates to a method and system for making digital content available to users of a mobile app via geo-located augmented reality objects (“ArKs”) that serve as portals through which the content may be accessed.

Unlike existing augmented reality viewing apps, the system and method of the invention not only enables users to view the augmented reality objects and access content, but also to establish, deploy, and manage their own augmented reality objects for viewing and interaction with by other users of the mobile app.

The method and system of the invention also provides an augmented reality ecosystem that, optionally, may include its own cryptocurrency to facilitate transactions arising from interaction with the augmented reality objects, and to facilitate compensation for digital content authored by and made available to viewers of the augmented reality objects, or to users of a content securing and authenticating system of the type disclosed in Tautachrome, Inc.'s U.S. Pat. Nos. 9,582,842; 10,019,773; and 10,019,774.

In addition, the system and method of the invention may use blockchain technology to create transaction records for ownership transfers and enable viewers to verify authenticity before interacting with the content of an augmented reality object, thereby reducing opportunities for fraud.

Potential applications for the augmented reality objects created and managed through the method and system of the invention include deployment of the augmented reality objects to identify and interact with persons on a social network, use of the augmented reality objects to provide advertising, information and transaction capabilities at stores or other location, use of the augmented reality objects to associate information with objects such as gravestones, and an essentially unlimited variety of other applications.

### 2. Description of Related Art

Augmented reality software for overlaying augmented reality images on live images captured by a mobile device, smart glasses, or other viewing or display devices are known, and is utilized by the present invention. For example, U.S. Pat. Nos. 9,773,285, 9,536,251, and 8,929,591 all disclose augmented reality systems that overlay augmented reality objects, referred to as “indicators,” on images captured by a mobile communications device utilizing mobile app software and geo-location. The Pokemon Go™ augmented reality game also utilizes mobile app software that overlays location-linked virtual reality objects on images captured and displayed by the mobile device. However, the present invention provides additional features that are not included in the previously-proposed or implemented systems, including provision for users to not only interact with, but also generate and control augmented reality objects referred to as “ArKs” through a mobile app.

For example, U.S. Pat. No. 8,929,591, discloses a mobile device that overlays geo-located augmented reality objects on a captured image The augmented reality objects are referred to as “indicators” and serve as portals to a wide variety of content, including information, images, video, and links to restaurant reservation or e-commerce “interactive tabs.” However, the viewing app does not empower the viewer to do anything other than view and interact with content created by others, and does not allow users of the mobile device app to create their own indicators, much less locate and manage them.

By way of further background, U.S. Pat. No. 9,773,285 discloses indicators that are similar to those disclosed in U.S. Pat. No. 8,929,591, except that the indicators are summoned by object recognition rather than geolocation, while U.S. Pat. No. 9,536,251 discloses interactive virtual entities that are superimposed on images based on “markers” made up of real objects in the image, and in particular QR codes. Other object recognition based augmented reality methods and systems are disclosed in U.S. Pat. Nos. 8,180,396; 7,751,805; and 8,542,906. On the other hand, U.S. Pat. Nos. 9,317,600 and 8,432,414 both disclose systems that utilize geolocation to add non-interactive captions to objects in an image based on their location.

Also by way of background, U.S. Pat. Nos. 9,511,291, 8,542,906; 6,765,569; 6,587,601; 6,208,353; 6,064,749 all disclose procedures for precisely aligning image augmenting content with objects in the original image, which is not necessary in a system that simply locates the augmented reality image based on geographic coordinates and possibly a fixed offset. Such alignment procedures have in general been rendered obsolete by the vastly improved precision of modern geo-location systems, which allow even a smartphone to determine precise locations.

Additional background art includes the following: U.S. Pat. No. 10,037,343 discloses a system that enables interaction with augmented reality objects such as the ones displayed by Pokemon Go™, or those generated by the “Monocle feature in Yelp's mobile app¹” or “a pointing search app such as Go Lauderdale mobile app.” U.S. Pat. No. 8,315,423, is directed to a system that displays information, such as ads, based on identification of real objects in an image uploaded to a server. U.S. Pat. No. 7,751,805, discloses retrieval of information based on recognition of real objects such as faces, bar codes, or works of art. U.S. Pat. No. 9,519,924, discloses distribution of information to members of a social network who have interest in a real object captured by one of the members and identified by the server, while U.S. Pat. No. 8,873,807 describes retrieval of information for an automobile based on an image of the VIN, and superposition of the retrieved information on an image of the automobile, and U.S. Patent Publication No. 2018/0053021 discloses augmentation of an image of a headstone with content based on geolocation and a digital tag. Finally, U.S. Patent Publication No. 2002/0102813 discloses an augmented reality system that enables users to upload images for identification of content, but does not disclose any image augmentation.

These references collectively show that methods and systems for using augmented reality objects in entertainment or e-commerce, based on geolocation or object recognition, are well known. However, none of these references are directed to the “back end,” i.e., to methods and systems that all users not only to view and interact with augmented reality objects created by others with specialized programming skills, but that also allows general users to create, locate, and manage their own augmented reality objects (ArKs), thereby making augmented reality an integral part of the virtual universe, in much the same way that Facebook enabled general users to create their own websites, vastly expanding the number of participants in cyberspace.

### SUMMARY OF THE INVENTION

It is accordingly an objective of the invention to provide a method and system that utilizes augmented reality objects, hereinafter referred to as “ArKs,” to enable users to access content, including interactive content, and that further enables users to create, manage, and deploy their own ArKs.

If is a further objective of the invention to provide a cryptocurrency for facilitating payments involving ArKs and other digital content created by users of the cryptocurrency.

It is yet another objective of the invention to create an ArK ecosystem in which ArKs are utilized to provide easy access to digital information and interactive digital content in a wide variety of contexts, across different computing platforms, and for users of all technical abilities.

These and other objectives of the invention are accomplished by a method and system in which ArKs may be both viewed and deployed through a mobile device app, optionally in association with a “cyborg” type display device, the ArKs serving as digital information containers owned and deployed by a user of the app or a third party such as a store owner, and which are associated with one or more specific locations, addresses, or devices, including a user's mobile communications device.

In the case of an ArK associated with the user's device, when the user moves around, so does the ArK's location in geo-space. On the other hand, a retail store's ArK might be geolocated at the store's geolocation, while a museum might deploy an ArK of information at each of its exhibit locations.

In a preferred embodiment, the method and system of the invention provide a downloadable mobile device app that enables users to create their own ArKs and to achieve the benefits of opening other people's geolocated ArKs containing valuable information that the other ArK owners may wish to provide. The ArK app is intended to be used by everyone globally and to be deployed as a network of ArKs, (an “ArKnet”) supporting ArK2ArK interaction facilitated by peer to peer software, by ArKnet server provided software, or by combinations thereof).

Although the mobile device app of the preferred embodiment has the capability of both viewing and creating/managing ArKs, it is not required that an ArK be created by the app in order to be viewed by the app, or that an ArK created by the app be viewed through the app. While the mobile device app provides a simple way for users to view and create ArKs, thereby expanding the ArK ecosystem, it is possible for ArK viewing and creation/management to also be carried out by means other than mobile device apps, on a variety of platforms, and in addition that ArK viewing and/or creation/management features be integrated with apps or software for other purposes, such as the “Klickzie” image authentication apps or software described in Tautachrome, Inc.'s U.S. Pat. Nos. 9,582,842; 10,019,773; and 10,019,774.

In keeping with the objective of creating an ArK ecosystem, there is no limitation as to what content may be provided, including information in the form of text, images, videos, e-coupons or vouchers, etc. associated with the geolocation, interfaces that enable feedback or uploading of content, and links to other websites or cloud applications. The ArKs may be associated with a fixed location or address, such as a store, monument, gravestone, etc., or associated with a device non-stationary object or person, based on the location of the object or person, or a device identifier such as a SIM identification code or IP address (so that the ArKs would appear when the user of the app is in geographic proximity to the object or person).

In addition, there is no limitation as to the forms that the ArKs can take, including not only static information bubbles or icons, but also images that appear to float and spin. In the preferred embodiment of a mobile device, the user may select from a list or library of ArKs, or create his or her own ArK.

Still further, the ArKs of the method and system of the invention may be placed at any location the creator/owner thinks best, and can be made visible or invisible to other classes of ArK owners in any lawful manner whatsoever, subject only to avoidance of visibility collisions of competing ArKs, which can be handled by the app provider or a decentralized blockchain arrangement. The ArK and its contents can be monetized in any lawful manner whatsoever, including license or sale of the ArKs themselves or their content, or by providing “pay to see” options in which the owner enables fee charging mechanisms under contractual arrangements provided as part of the ArK app. Also, an ArK can be placed in as many locations as the ArK owner thinks best with limitations determined only by fee factors applied by the app. Nobody owns what a person wishes to see at locations where people freely go.

In order to reduce the chance that ArKs can be used to trick people into fraudulent transactions or revealing information in phishing scams, the mobile app can provide additional safety by utilizing blockchain technology to verify the ownership of an ArK and track its usage. For example, whenever a user creates an ArK, sells their ArK, or buys an ArK, a corresponding blockchain transaction record can be created for anyone to view.

Although the preferred embodiment of the invention involves a display on a mobile device, it will be appreciated by those skilled in the art that augmented reality (AR) displays can be implemented using what are known as imaging cyborg technologies, or devices that cause the ArK to appear directly in the field of vision of the user. For ease of presentation, the illustrated embodiment presents the ArK overlay as happening on the imagery of a digital camera that is visualizing a user's environment. However, AR imaging cyborgs are not limited to such displays. AR presentations can be made on the surface of head worn glasses where the wearer is seeing the real world and AR information is projected onto the glass but aligned to appear on or near a real object in the wearer's field of view. In addition, there are AR technologies aimed at projecting AR information directly onto the observer's retina. In that case, there is no medium at all between the observer's eye and the real world. Accordingly, any method for inserting virtual AR information into the observer's visual imagery applies to the method and system of the present invention, whether the imagery is camera digital imagery, natural imagery seen through glass, natural imagery seen without any intervening material at all, or any other imaging cyborg presenting virtual AR information onto visual imagery.

### BRIEF DESCRIPTION OF THE DRAWINGS

FIG. 1 is a schematic diagram illustrating an ArK deployment and viewing arrangement according to an illustrative first preferred embodiment of the invention.

FIG. 2 is a block diagram showing components of a mobile device modified by the inclusion of a ArK viewing and creating/managing app utilized by the method and system of the preferred embodiment.

FIGS. 3-6 illustrating procedures for ArK creation and deployment using a mobile app in accordance with the principles of the first preferred embodiment of the invention.

FIG. 7 is a schematic diagram of a cryptocurrency arrangement that may be used in the preferred embodiment of FIGS. 1-6.

FIGS. 8 and 9 are flowcharts illustrating procedures for viewing and interaction with ArKs utilizing a mobile device app such as the mobile device app of the embodiment of FIGS. 1-6.

FIG. 10 is a flowchart illustrating use of the cryptocurrency of FIG. 7 in connection with the method illustrated in FIGS. 8 and 9.

### DETAILED DESCRIPTION OF THE PREFERRED EMBODIMENTS

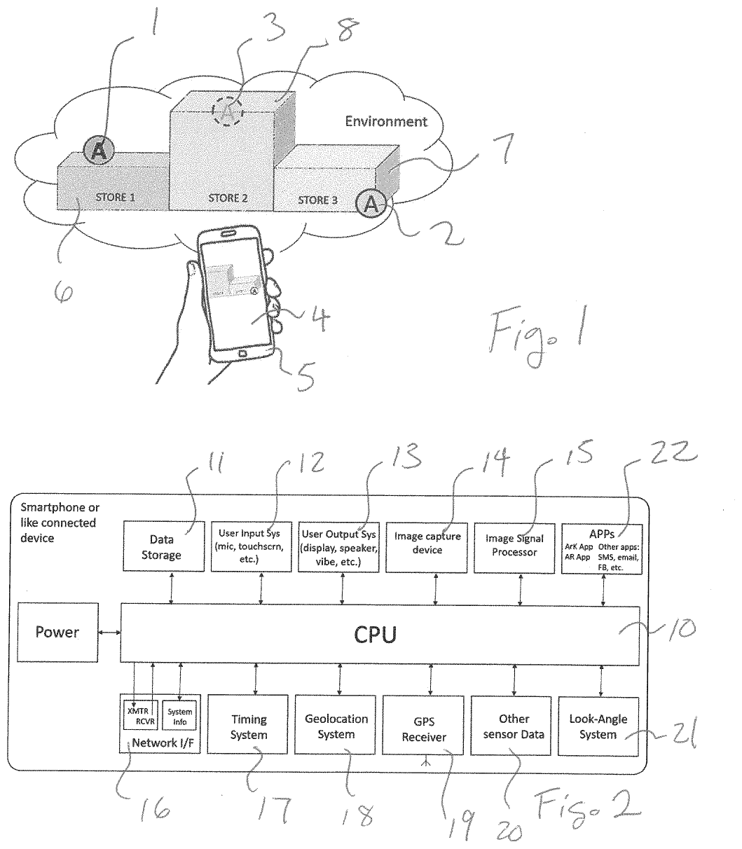

FIG. 1 is a schematic diagram illustrating principles of a preferred embodiment of the invention, in which augmented reality objects 1-3 referred to herein as “ArKs” are inserted into an image 4 captured by a mobile device 5. Although the captured image is depicted as including three entities 6-8 labeled as “stores,” the invention can be applied to a wide variety of different entities visible in a captured image, including both inanimate and living objects, whether stationary, movable, permanent, or transitory, as will be described in more detail below.

In a preferred embodiment of the invention, the ArKs 1-3 are inserted into the image by a mobile app, based on the location and orientation of the mobile device when it captures the image. In the illustrated example, only ArKs 1 and 2 are visible to all users of the smartphone app, while ArK 3 may be invisible some users but visible to other users, based on information provided by the user and owner/originator of the ArK. It is also possible to make the ArKs visible to the user through a device other than a mobile communications device, and in particular through what is known as imaging cyborg technology in which the ArK is caused to directly appear in the field of view of the person using the app, through a device such as smart glasses, corneal implants, or any other such technology.

Mobile device 5 may be a smartphone, smartwatch, tablet, or similar portable device carried by the user and capable of receiving and installing software for carrying out the imaging and interactive functions described herein. Such software is known as a mobile app, although it is not limited to any particular programming language, operating system, or platform. FIG. 2 shows required components of the mobile device 5, including a hardware central processing unit (CPU) 10 and data storage 11, and various units that may include or be implemented as hardware, programmed firmware, or software instructions for execution by the CPU 10. The units include a user input interface 12, which may include a microphone, a touchscreen, a keypad, an orientation or motion sensor, or any other input device or combination of input devices, and an output interface 13, which may include a display screen (such as the touchscreen), a speaker, and/or a vibration generating device. The mobile device also includes an image capture device 14, such as a camera or CCD sensor, an image signal processor 15, which may be a separate integrated circuit or included in the CPU, a network interface 16, including a transceiver, SIM card, and/or any other device or circuit that allows wireless communications, a timing system or clock 17, which may be included in the CPU, a geolocation system 18, which may include circuitry for processing location signals from the cellular network or received by a GPS, GNSS, or GLONASS transceiver 19 as well as additional sensors 20 such as motion, acceleration, and/or sensors, and magnetometer or other sensors or devices 21 for determining an orientation or direction of the mobile device 4. Finally, the mobile device includes mobile apps 22, and in particular an ArK app for implementing the method and system of the invention, as described below.

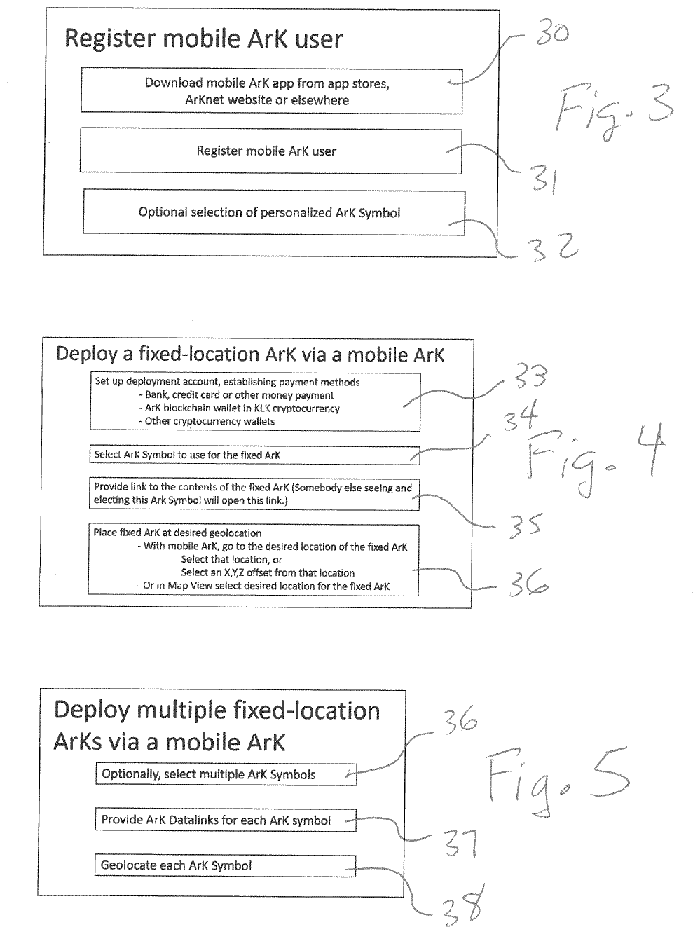

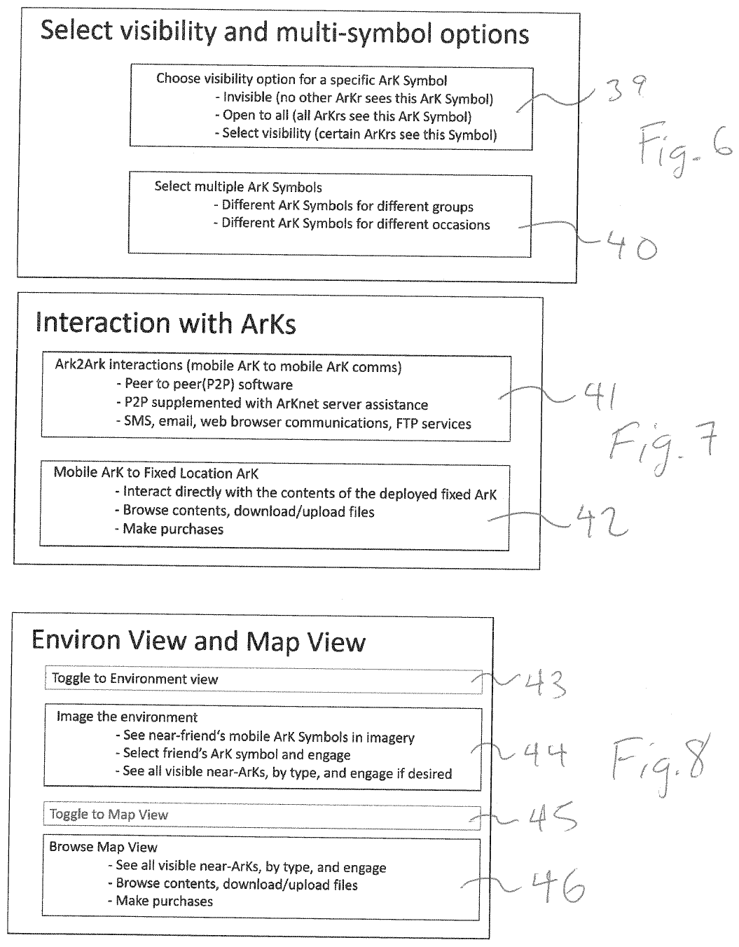

It will be appreciated by those skilled in the art that software for overlaying augmented reality images on captured images based on geolocation is known, and can be utilized by the present invention. For example, U.S. Pat. Nos. 9,773,285, 9,536,251, and 8,929,591 all disclose augmented reality systems that overlay augmented reality objects on captured images based, as least in part, on geolocation. The Pokemon Go™ augmented reality game is another example of mobile app software that overlays location-linked virtual reality objects on captured images. However, the present invention provides additional features that are not included in the previously-proposed or implemented systems, including provision for users to not only interact with, but also generate and control ArKs through the mobile app, as illustrated in FIGS. 3-6.

In particular, as shown in FIG. 3, in contrast to existing geo-location based augmented reality systems, in which the mobile app only provides a front end that displays and possibly allows some interaction with the augmented reality objects, the mobile device app of the present invention also provides an ArK creation, deployment, and/or management interface for establishing, deploying and managing augmented reality objects, i.e., ArKs, that can be viewed by others.

According to step 30 of a first preferred embodiment of the invention, a user downloads the mobile app to a mobile device of the type illustrated in FIG. 2, and registers the app (step 31). As part of the registration procedure, the app can capture the unique mobile device identification, which can be used to identify the owner of an ArK. In addition, the app may require identity confirmation by in-person registration or any existing Know Your Customer (KYC) methods, although it is also possible to provide for anonymous registration.

In step 32, the user selects at least one personal ArK symbol or ArK avatar, which can be a generic ArK symbol, a symbol that is selected from a list or library containing available ArK symbols, images, or GIFs, a symbol that is created by the user using an image or symbol using drawing software, or a symbol that is created by selecting and modifying an existing image possessed or downloaded by the user.

FIG. 4 shows an illustrative procedure for deploying a geo-located ArK, i.e., for setting up the locations at which the app user's ArK will be visible to the other users, the types of interaction with the ArK that are permitted, and the set of person who are capable of viewing the ArK and/or interacting in defined ways with the ArK. Step 33 refers to an optional step of setting up a deployment account, which will enable the user setting up the ArK, referred to herein as “owner,” to receive compensation or payments from persons viewing and interacting with the ArK, or from another entity based on the interactions and/or ArK views, and also to make payments to the provider of the app and to others. The account would be a bank account, credit card account, payment service such as 4 Square or Paypal, an Ark Blockchain Wallet (described below in connection with FIG. 7), or another cryptocurrency wallet.

In step 34, the app user selects a symbol for the fixed ArK, either from a list or template, or of the user's design and, in step 35, the user establishes a link to the contents of the ArK. Finally, in step 35, the user establishes a geo-location for the ArK, either by going to the desired location and using the ArK app to set the ArK's position, or by using a Map View to locate the ArK. If the user selects the option of utilizing the mobile device's location determining capabilities to record the location as which the ArK is to be positioned, the location can be established by determining the exact position of the mobile device and, optionally, adding an offset so that the ArK can be positioned above or below the user's position, or near the user's position in but in at a location that the user is not able to actually enter (for example, the ArK could be located so that it floats above the viewer or appears in an inaccessible location such as a shark tank at an aquarium).

The content of the fixed ArK, i.e., the data and programming accessed when a viewer selects the ArK, may be information, video, audio, another mobile app, or a website through which the viewer can carry out transactions such as making a purchase. The purchase can be carried out through the blockchain wallet by debiting the viewer's wallet and crediting the owner of the ArK. Alternatively, the owner of the ArK may receive compensation each time a viewer selects the ArK, with the compensation being credited to the user's account, either in conventional or crypto currency, such as the crypto currency described below.

As part of the ArK creation procedure, the mobile app can also use blockchain technology to create a blockchain record of the ArK's creation and ownership, allowing anyone who subsequently interacts with the ArK to verify its ownership and any transactions that involve the ArK, in a manner similar to the manner in which cryptocurrency transactions are verified by updating a blockchain whenever a transaction involving the cryptocurrency occurs. Use of blockchains provides additional safety for anyone who wishes to take part in the ArK ecosystem.

The user may also be provided with the option of deploying multiple fixed location ArKs, as illustrated in FIG. 5, which includes optional step 36 of selecting multiple ArK symbols, step 37 of providing content links for the multiple symbols or a single symbol, and step 38 of geolocating the ArKs in the manner described above. It is not necessary to provide a different Ark at each geolocation, so step 36 and/or step 37 may be omitted and the same ArK may be located at different locations. Alternatively, the app user may choose to use different symbols at different locations for the same content, or to use the same symbol at different locations to link to different location-appropriate content.

In step 39, the app user is given the option of selecting visibility options that enable the app user to choose whether all or just some of potential viewers are able to see the ArKs when using the app on their mobile device, and also the identities or group-affiliations of those able to view the ArKs or interact with the Arks in a predetermined way. In step 40, the app user can also select multiple symbols for individual ArKs, so that different groups see different augmented reality images when viewing the same ArK, or so that the augmented reality images change over time, for example seasonally or on special occasions or holidays.

There is no limit as to either the form or the content of the geo-located ArKs created and viewed by the method and system described above, as can be understood from the following examples:

In a first example, a large stadium is filled with people. An individual with an ArK-equipped smartphone could query “Where are the friends I'm supposed to meet here?” By panning the phone's camera around the stadium, the individual's ArK equipped friends could be geolocated by the ArK app using Augmented Reality to place an ArK above each friend, thus providing a visual geolocation of the friends, as well as a means to identify and interact with any or all of the friends by selecting (e.g. by touching) the desired ArK.

In a second example involving a shopping mall, the ArK app, via the smartphone digital camera using AR software, identifies each ArK equipped store with an ArK Symbol overlaid in the imagery and placed in front of the store, in the manner illustrated in FIG. 1. By touching the store's ArK Symbol in the imagery, the user opens the store's ArK to see what is inside: products, specials, live chat links or whatever the store wishes to keep in the ArK. In general, the types of interactions that can be carried out with such an ArK is virtually unlimited. Information in an ArK might be browsed and downloaded, forms might be filled in, purchases made, licenses executed, or other financial transactions accomplished. Direct contact between the ArK's owner or agent(s) and any permitted viewer or opener of the ArK may be by voice, text, video or any other manner of interaction, at the discretion of the ArK's owner as determined during the ArK creation procedure.

Yet another example involves an acrobat named “Juan” on a street corner. Juan the acrobat videographs himself doing an amazing street performance on a popular corner in New York. He removes the background, creates an ArK of the cleaned up video, geolocates the ArK on that corner, and leaves an animated GIF of his slickest move as his AR Symbol. ArK equipped passersby open the ArK and watch the performance for a fee. Juan makes money on the street corner without having to travel into the city. Then Juan realizes an amazing feature of the ArK app. He can, for a fee, multiply the locations of his performance to other street corners where he has never been and may never go. Soon Juan has his performance ArK located on every major pedestrian corner in the large cities in the US, and not stopping there, expands to the rest of the Western hemisphere then to the rest of the world. (Juan becomes rich and retires in a modest dwelling in the fishing village of Puerto Penasco on the Sea of Cortez.)

In another example, a weather ArK is arranged to appear in the sky above a viewer whenever the viewer points his mobile device camera in an upward direction. When the viewer touches the ArK Symbol on his or her mobile device screen, the viewer can download today's weather forecast at his or her exact location and surroundings. Alternatively or in addition, if a commercial airliner passes through the image while the viewer is pointing the camera in an upward direction, an ArK can be superimposed on the airliners, and used to provide flight and aircraft information: departure point, destination, carrier, flight number, number of passengers and crew, cabin configuration, aircraft type, date and source of manufacture, and even flight hours since last maintenance.

Another example involves placement of ArKs in a cemetery. Typically, a gravestone marks the resting place of a deceased person but does not provide much information about the person other than a name, birthdate, and date of death. Using the ArK app, family and strangers can both bring the person “to life” by interacting with an ArK that appears on the gravestone. The ArK can contain a detailed biography of the person, pictures and videos of the person's life and whatever else it takes to turn a dash on the gravestone into a life remembered. The gravesite's geolocation would be recorded by a visit to the gravesite by a user of the ArK mobile app, who would then use the app to create and register the gravesite ArK. From then on, anybody capable of viewing the ArK who visits the cemetery could view the ArK symbols representing graves with ArK information, and open the ArKs to see real information on the life once lived and marked by that gravesite.

Still further examples of ways in which ArKs can be deployed or utilized include use of an ArK as a digital mailbox through which messages can be left for the ArK owner, or the ArK owner can leave messages for others, and use of a person's device ArK in place of a conventional social media profile, so that viewers of an ArK can view the user's social media profile (or any portion thereof) by interacting with the ArK. The ArK can also be utilized in a manner similar to a Tinder™ dating app profile, allowing persons to express interest in the owner by interacting with his ArK.

In any of the above examples, a user's interaction with an ArK visible on the screen of the user's mobile device (or otherwise visible to the user through imaging cyborg technology) can be, in the case of a mobile ArK, via peer to peer software with the mobile device of the ArK's owner, peer to peer communications via a server, or other communications means such as SMS, email, web browser communications, and FTP services, as indicated by block 41 in FIG. 7. In the case of a fixed ArK, as indicated by block 42, interaction with ArK can be through direct interaction with a device at the location of the ArK, or through a browser or webpage, such as an e-commerce webpage, or via file download and upload.

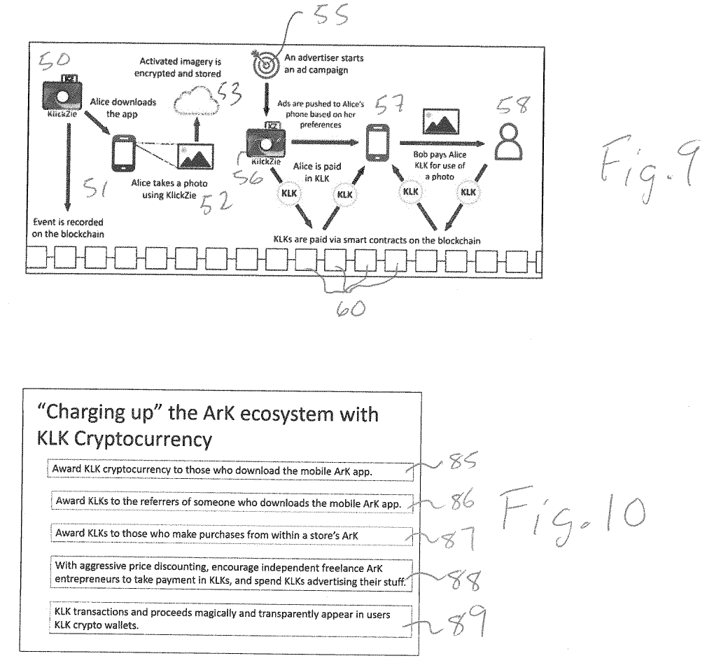

Furthermore, as illustrated in FIG. 8, the AR Symbols for existent ArKs in an observer's near environment may be viewed either as overlaid on the digital imagery of the observer's imager, as indicated by blocks 43 and 44, or in a map view, indicated by blocks 45 and 46, properly located on the map (referred to herein as a “Neary map”). In the map view of blocks 45 and 46, a Neary map may be scaled up to show ArKs beyond the near environment, allowing the ArK user to browse ArKs available to be seen by that user, whether locally or across the entire globe if desired. For example, in the case of ArKs placed at a cemetery, the ArKs can be viewed on a map of gravesites at the cemetery. Alternatively, by way of example and not limitation, the ArKs could be placed on a map of a shopping mall, or on a city or state map. In the example of a town (or a tourist site such as a monument, battlefield, castle, or museum), the ArKs could serve as tour guide that tells a story of the town and its history. ArKs could even be time or date stamped to serve as time capsules for viewing by future generations (probably through some future cyborg technology) or to advertise future or seasonal events.

Also in the map view, a user could be permitted to filter ArKs by content, so that the user could for example search for a specific type of restaurant, and open ArKs that meet the criteria in order to view menus, video of the venue, and make reservations.

As noted above, the ArKs can utilize a blockchain based cryptocurrency system of the type illustrated in FIG. 9 to facilitate transactions or payments to the app user, including a cryptocurrency system created especially for use with the method and system of the invention (Units of which may be referred to as KLKs). Such a “KLK” cryptocurrency is not limited to use in connection with the method and system of the invention, but also may be used in connection with other apps, such as the KlickZie™ imaging and authentication app described in U.S. Pat. Nos. 9,582,842; 10,019,773; and 10,019,774, each of which is assigned to Tautachrome, Inc. The KLK cryptocurrency may be supplied into the ecosystem by awarding the cryptocurrency to those who download and use the KlickZie™ imaging app, as well as anyone who downloads and uses the KlickZie™ imaging app. In addition, it is within the scope of the invention to provide routes of KLK injection into the ecosystem deriving from those who purchase KLKs from the KlickZie™ app provider for US dollars in order to award them to users of their products in the ecosystem.

Blocks 50-53 of FIG. 9 show an image capture sequence of the type described in the Tautachrome patents. The arrows connecting blocks 50-53 represent steps of capturing an image or video 52 by an app 50 on mobile device 41, and uploading of the image or video 52 to a server 53, the image or video 52 being marked and encrypted in such a way that its authenticity can be verified by anyone who subsequently views or utilizes the image or video. The KLK currency ensures that the person uploading the image or video, referred to FIG. 9 as “Alice,” can be paid for use of the images or video, as indicated in blocks 55-62. The arrow connecting blocks 55 and 56 indicates the start of an ad campaign, during which ads are pushed to from server 55 to Alice's app 56. Alice refers the ad to her friend Bob and gets paid in KLK cryptocurrency, as indicated by the arrows connecting blocks 56, the blockchain 60 that makes up each unit of cryptocurrency, and block 57 (Alice's phone/wallet). Bob also decides to use Alice's protected image, and pays her in cryptocurrency via the app, as indicated by the arrows connecting block 58, blockchain 60, and block 57. Each time a payment is made, the transaction is recorded in the blockchain 60.

The objective of the sequence shown in FIG. 9 is to energize general KLK currency usage through every means possible so that, for example, the street acrobat described above and every other ArK user will wish to accept KLKs in their monetary exchanges, which will have the effect of supporting a rise in the KLK currency price against other national or cryptocurrencies, further increasing KLK usage and value. In addition, this provides a convenient way for authors and composers to receive payment for use of images or compositions, the payment for which can unlock the image or composition for viewing or usage.

This energization is referred to in FIG. 10 as “charging up” the ArK ecosystem with KLK cryptocurrency,” and can be accomplished in a number ways, including awarding the cryptocurrency to anyone who downloads the ArK viewing and managing mobile app (step 85), refers a new user who downloads the app (step 86), makes a purchase through interaction with an ArK (step 87), make payments to content providers or authors that can be used by the providers or authors for advertisement or promotion (step 88). These steps shown in FIG. 10 all serve to prime the pump of the cryptocurrency ecosystem that the ArKnet will use, so as to empower the economic activity of the independent freelance entrepreneur or author in extending reach, multiplying following and growing wealth in the new blockchain cryptocurrency economy. Cryptocurrency will be awarded from the ArK app providers KLK treasury and from KLK revenues received by the ArK app provider for commissions on provider-facilitated KLK spending activity. In addition, fixed-position ArK pricing can be drastically reduced for users who take payment in KLKs, the effect of which will be to increase the relative value of KLKs to dollars in the KLK ecosystem. The power of painless, no cost, automated transaction results that characterize the blockchain universe will help to reduce the barriers for activity in this new ecosystem.

Ultimately, the KLK cryptocurrency can serve as a cryptocurrency for general transactions involving credit and debit of KLK wallets managed by the app and secured by blockchain (step 89 of FIG. 10). Even though created for use with the system and method of the invention, the KLK cryptocurrency may be a real currency, usable for any transaction purpose in addition to use as a medium of exchange for in-app transactions within the KlickZie™ ecosystem, and/or the system and method of the present invention. The ArK or KlickZie™ app provider will license for US dollars the ArK software to stores, businesses and other entities who want their ArKs to be seen by their customers. Licensees will pay a fee to KlickZie for purchases made via the licensee's ArK, a portion of which fee will be used by KlickZie to reward the purchaser with KLKs for using the ArK for the purchase. In that way customers will have KLKs to spend. In summary, the present invention provides a unique augmented reality ecosystem that allows augmented reality ArKs to be viewed and interacted with, but also to be created and managed, by the user of a mobile device. The diagrams above depict some of the elements of interaction between ArKs. On ArK app download a mobile ArK is created, personal to the user and tied to the user's smartphone device ID. In addition a KLK crypto wallet is transparently created. ArK2ArK communication is facilitated with peer to peer software couple with the app, and assisted by ArKnet servers where advantageous. This ability for peer to peer comms capability engendered within this essentially decentralized environment of ArK facilitated communication is a new type of social networking, and is an ideal environment for use and propagation of a crypto currency, as illustrated in FIG. 10.

Although the cryptocurrency of FIGS. 9 and 10 is not limited to the ArK ecosystem of FIGS. 1-8, it provides a synergistic link between the that environment and the larger world. Within the environment, it frees the user to interact with other individuals by deploying and interacting with ArKs in any way that humans normally interact, greatly expanding the possibilities of a conventional social network without the limitations.

What is claimed is:

1. A method of deploying, managing, and interacting with augmented reality objects, comprising the steps of:
installing a mobile device app on a mobile device, the mobile device app including instructions to be executed by a central processing unit of the mobile device for causing the mobile device or a cyborg device to superimpose an augmented reality object on an image displayed on the mobile device or cyborg device,
wherein the augmented reality object is linked to a geographic location, address, or second mobile device and serves as a portal to content linked to the augmented reality object;
wherein the mobile device app further enables a user of the downloaded mobile device app to create, locate, and deploy a personalized said augmented reality object for viewing and interaction with users of other mobile devices or cyborg devices in proximity to a set location of the personalized augmented reality object.

2. A method as claimed in claim 1, wherein the augmented reality object is created, located, and deployed by performing the following steps:
the user selecting a symbol for the augmented reality object from a list or library of symbols, or by the user creating the symbol;
the user linking content to the augmented reality object, said content selectively including information, images, video, forms, and links to programs, applets, webpages, or other interactive content; and
the user selecting a location or address for the augmented reality object.

3. A method as claimed in claim 2, wherein location is a fixed location and the fixed location is selected by the user going to a desired location, using the mobile app to select the location, and selecting an offset from that location.

4. A method as claimed in claim 2, wherein the location is a fixed location and the fixed location is selected by designating a location in a map view displayed by the mobile app.

5. A method as claimed in claim 2, wherein multiple locations are selected for a single said augmented reality object.

6. A method as claimed in claim 2, further comprising a step of the user selecting a visibility option that determines who is enabled to view and/or interact with the augmented reality object.

7. A method as claimed in claim 6, further comprising a step of the user selecting different augmented reality object symbols for different groups of viewers or occasions.

8. A method as claimed in claim 2, wherein during creation of an augmented reality object, the mobile app uses blockchain technology to create a blockchain record of the augmented reality object's creation and ownership, allowing anyone who subsequently interacts with the augmented reality object to verify its ownership and any transactions that involve the augmented reality object.

9. A method as claimed in claim 1, where the mobile app enables toggling between a mode in which augmented reality objects are superimposed on a live image captured by a camera of the mobile device, and a mode in which augmented reality objects are placed on a map view.

10. A method as claimed in claim 9, wherein a user of the mobile app can perform a search for augmented reality objects in the map view that meet input criteria, and filter out augmented reality objects that do not meet the input criteria.

11. A method as claimed in claim 1, in which the mobile app enables direct interaction with content linked to an augmented reality object selected for viewing by a user, browsing of the content, downloading and uploading of files associated with the augmented reality object, and purchases based on viewed content.

12. A method as claimed in claim 1, wherein the user is identified, at least in part, by an identification number of the user's mobile device.

13. A method as claimed in claim 1, further comprising the step of the user establishing an account through the mobile device for receiving and making payments resulting from interactions with the user's augmented reality objects and other users' augmented reality objects.

14. A method as claimed in claim 13, wherein the account is an electronic wallet and payments are received and made using a blockchain-based cryptocurrency.

15. A method as claimed in claim 14, further comprising the steps of charging an augmented reality ecosystem that includes multiple said augmented reality objects and users by one or more of the following steps: (a) awarding the cryptocurrency to those who download the mobile app; (b) awarding the cryptocurrency for referrals to other users who download the mobile app; (c) awarding the cryptocurrency to those who make purchases by interacting with the mobile app; (d) encouraging entrepreneurs who have deployed the augmented reality objects to take payment in the cryptocurrency; and (e) encouraging transactions to be carried out using the cryptocurrency.

16. A method of creating and augmented reality ecosystem made up of augmented reality objects, comprising the steps of:
offering a mobile device app for installation on mobile devices, the mobile device app including instructions to be executed by a central processing unit of a respective mobile device for causing the respective mobile device or a cyborg device to superimpose an augmented reality object on an image displayed on the respective mobile device or cyborg device,
wherein the augmented reality object is linked to a geographic location, address, or one of the mobile devices and serves as a portal to content linked to the augmented reality object;
wherein the mobile device app further enables a user of the downloaded mobile device app to create, locate, and deploy a personalized said augmented reality object for viewing and interaction with users of other mobile devices or cyborg devices in proximity to a set location of the personalized augmented reality object.

17. A method as claimed in claim 16, in which the mobile app enables direct interaction with content linked to an augmented reality object selected for viewing by a user, browsing of the content, downloading and uploading of files associated with the augmented reality object, and purchases based on viewed content.

18. A method as claimed in claim 16, further comprising the step of enabling users to establish accounts through the mobile device for receiving and making payments resulting from interactions with the user's augmented reality objects and other users' augmented reality objects.

19. A method as claimed in claim 18, wherein the account is an electronic wallet and payments are received and made using a blockchain-based cryptocurrency.

20. A method as claimed in claim 19, further comprising the steps of charging the augmented reality ecosystem that includes multiple said augmented reality objects and users by one or more of the following steps: (a) awarding the cryptocurrency to those who download the mobile app; (b) awarding the cryptocurrency for referrals to other users who download the mobile app; (c) awarding the cryptocurrency to those who make purchases by interacting with the mobile app; (d) encouraging entrepreneurs who have deployed the augmented reality objects to take payment in the cryptocurrency; and (e) encouraging transactions to be carried out using the cryptocurrency.

21. A method as claimed in claim 16, wherein augmented reality objects in the ecosystem are protected by blockchain technology.

22. A system for deploying, managing, and interacting with augmented reality objects, comprising:
at least one entity for supplying mobile device apps to users of mobile devices, each mobile device app including instructions to be executed by a central processing unit of a respective mobile device for causing the mobile device or a cyborg device to superimpose an augmented reality object on an image displayed on the mobile device or cyborg device,
wherein the augmented reality object is linked to a geographic location, address, or second mobile device and serves as a portal to content linked to the augmented reality object;
wherein the mobile device app further enables a user of the downloaded mobile device app to create, locate, and deploy a personalized said augmented reality object for viewing and interaction with users of other mobile devices or cyborg devices in proximity to a set location of the personalized augmented reality object.

23. A system as claimed in claim 22, wherein the system is arranged to enable a user to create, locate, and deploy a augmented reality object by performing the following steps:
selecting a symbol for the augmented reality object from a list or library of symbols, or by the user creating the symbol;
linking content to the augmented reality object, said content selectively including information, images, video, forms, and links to programs, applets, webpages, or other interactive content; and
selecting a location or address for the augmented reality object.

24. A system as claimed in claim 23, wherein location is a fixed location and the fixed location is selected by the user going to a desired location, using the mobile app to select the location, and selecting an offset from that location.

25. A system as claimed in claim 23, wherein the location is a fixed location and the fixed location is selected by designating a location in a map view displayed by the mobile app.

26. A system as claimed in claim 23, wherein multiple locations are selected for a single said augmented reality object.

27. A system as claimed in claim 23, wherein the user is enabled to select a visibility option that determines who is enabled to view and/or interact with the augmented reality object.

28. A system as claimed in claim 27, further comprising a step of the user selecting different augmented reality object symbols for different groups of viewers or occasions.

29. A system as claimed in claim 23, wherein during creation of an augmented reality object, the mobile app uses blockchain technology to create a blockchain record of the augmented reality object's creation and ownership, allowing anyone who subsequently interacts with the augmented reality object to verify its ownership and any transactions that involve the augmented reality object.

30. A system as claimed in claim 22, where the mobile app enables toggling between a mode in which augmented reality objects are superimposed on a live image captured by a camera of the mobile device, and a mode in which augmented reality objects are placed on a map view.

31. A method as claimed in claim 29, wherein a user of the mobile app can perform a search for augmented reality objects in the map view that meet input criteria, and filter out augmented reality objects that do not meet the input criteria.

32. A system as claimed in claim 22, in which the mobile app enables direct interaction with content linked to an augmented reality object selected for viewing by a user, browsing of the content, downloading and uploading of files associated with the augmented reality object, and purchases based on viewed content.

33. A system as claimed in claim 22, wherein the user is identified, at least in part, by an identification number of the user's mobile device.

34. A system as claimed in claim 22, further comprising the step of the user establishing an account through the mobile device for receiving and making payments resulting from interactions with the user's augmented reality objects and other users' augmented reality objects.

35. A system as claimed in claim 33, wherein the account is an electronic wallet and payments are received and made using a blockchain-based cryptocurrency.

36. A system as claimed in claim 34, wherein the system is charged with the blockchain-based cryptocurrency by: (a) awarding the cryptocurrency to those who download the mobile app; (b) awarding the cryptocurrency for referrals to other users who download the mobile app; (c) awarding the cryptocurrency to those who make purchases by interacting with the mobile app; (d) encouraging entrepreneurs who have deployed the augmented reality objects to take payment in the cryptocurrency; and (e) encouraging transactions to be carried out using the cryptocurrency.
